(19) United States
(12) Patent Application Publication
(10) Pub. No.: US 2024/0121297 A1
(43) Pub. Date: Apr. 11, 2024

(54) METHOD AND APPARATUS FOR DISTRIBUTED SYNCHRONIZATION

(71) Applicants: PRAVEEN VADDADI, HYDERABAD (IN); PRANEETH VADDADI, HYDERABAD (IN)

(72) Inventors: PRAVEEN VADDADI, HYDERABAD (IN); PRANEETH VADDADI, HYDERABAD (IN)

(21) Appl. No.: 18/143,070

(22) Filed: May 4, 2023

(30) Foreign Application Priority Data
Oct. 11, 2022 (IN) 202241064293

(51) Int. Cl. H04L 67/104; H04L 67/1095

(52) U.S. Cl. CPC H04L 67/1059; H04L 67/1051; H04L 67/1095

(57) ABSTRACT

In one aspect, a computerized system comprising: a plurality of nodes interlinked by uniform or non-uniform communication links, wherein each node of the plurality of nodes switches between a propagator mode of operation or non-propagator modes of operation; wherein a first node comprises a computerized synchronization system, wherein the computerized synchronization system synchronizes the data in the plurality of nodes and tracks of all events made on one or more local data units and synchronizes along with the identifiers of the plurality of nodes: a local data storage system that saves and retrieves a plurality of timestamps; a processor to perform basic atomic operations on the plurality of timestamps; an internal clock, wherein a time of the internal clock is modulated by a device; a device which receives messages and data and measures a time of reception and a control time of sending messages and data; a central controller to coordinate all the components in the device; a mode modulator that performs a propagator mode operational transition or a non-propagator mode operational transition; and an internal log that maintains a log of history of events and changes made within a node.

### PRIORITY CLAIM

This application claims priority under Article 4A of the Paris Convention for the Protection of Industrial Property to Indian Patent Application No. 202241064293, filed on Oct. 11, 2022 and titled METHOD AND APPARATUS FOR DISTRIBUTED SYNCHRONIZATION.

### BACKGROUND

The need for online communication and cooperation, data, and time synchronization, drives the adoption of consistency control methods in fields as diverse as game development, video editing, collaborative programming, radio networks, IoT, local-caching based systems with delayed network I/O, networks of autonomous cars exchanging data, and so on. For example, in a collaborative document editing environment, it is necessary to handle synchronization and conflicts quickly across numerous computers on a network, where copies may be updated independently and concurrently. In another case, an autonomous vehicle may exchange data with a fleet of other autonomous vehicles and other mobile devices in order to jointly update operational vehicular data. One autonomous vehicle and a set of mobile devices may require replicas of data hosted by another vehicle in order for data updating and processing to be based on the most recent data set, and one mobile user and a vehicle may concurrently modify data shared between multiple vehicles, each of which has a replica of the shared data.

Events in a distributed system can occur in a nearby place, such as many processes running on the same computer, at nodes inside a data center, geographically spread across the globe, or even on a larger scale. Various procedures for distributed synchronization and consistency control such as in ad hoc networks are currently known from the prior art.

Apart from methods that rely on the availability of a shared external reference (such as a global central truth for data or time), the consistency control tree approach is the most commonly employed method. In a distributed scenario, such as updating a multi-user database, a single node is designated as the clock reference or consistency control master. The other nodes are gradually synchronized on that reference node by establishing a consistency control tree in a decentralized manner. Nodes in the vicinity of the reference node are synchronized with it, followed by nodes two hops away, which are synchronized by picking a node one hop away as the parent, and so on. Prior literature indicates that the amount of space required for the information required to determine causal relationships in distributed systems is linear. That is, no tracking method smaller than O(n) correctly describes causality in an n-node network. This is a concern in ad hoc networks, wireless sensor networks, mobile networks, and so on, since as node density grows, so do tracking costs.

Other methods studied in prior art are based on logical clocks that are used to keep track of how events happen in a distributed system. For example, Vector clocks are used to track causality (which defines a partial order than total order between events, and where two events are related only if they must be due to, for e.g. data dependencies). This abstracts away the complexities of keeping clocks in sync or even dealing with relativistic issues, at the expense of being able to order fewer events. But, in an ad hoc setting where nodes are added or removed in a large and unpredictable manner, handling adding and taking away nodes on their own without having to use a process that happens outside the clock is difficult and adds high operational costs. Restricting the number of participants in such a logical clock solution by intelligently selecting the nodes for which causal relationships are recorded (e.g. database replicase in a distributed database environment) may aid in conserving space and reducing complexity, but at the expense of availability. Other solutions exist in the prior art, such as weighing the causality requirements (based on priority) and relaxing causal connections that are not relevant to the underlying application, etc. However, convergence is sluggish and ill-suited to mobile networks, ad hoc networks, and IoT, etc.

Prior art methods present a number of drawbacks when it comes to ad hoc networks like wireless sensor networks, peer-to-peer networks, devices connected in a network with delayed I/O, etc., because of limited resources of energy, high density of nodes, etc. In practice, if the network is split up, it becomes necessary to choose, in the part containing the reference node, another reference node. Later, if the networks merge again, two reference nodes cannot be maintained. Moreover, even if the network remains connected, since the positions of the nodes change, the consistency control tree must be modified to avoid creating a local loop. In cases where a reference node leaves the network or crashes, the situation must be detected and requires a follow-up procedure of decentralized election of a new reference node. These fairly unresponsive and difficult procedures add high operational, performance and computational costs.

The limitations of current methods to ad hoc networks, such as wireless sensor networks, peer-to-peer networks, devices linked in a network with delayed I/O, etc., stem from factors such as limited energy resources, high density of nodes, and so on. As a result, if the network is partitioned, a new reference node must be selected for the section that formerly included the original node. Later, if the networks recombine, it will be difficult to keep track of two reference nodes. Even if the network does not disconnect, nodes' locations will shift, necessitating adjustments to the consistency control tree to prevent a local loop. If a reference node goes offline or crashes, it's important to notice so that a new one may be elected in a decentralized fashion. These rather slow and convoluted operations come with substantial overhead in terms of time, effort, and resources.

In summary, the current state of the art in decentralized synchronization and causality tracking of changes to data either: call for completely unique global identities; don't recycle old IDs from inactive nodes/participants, or require garbage collection of IDs; require global cooperation to remove useless/unused identifiers; CRDTs can propagate edits through a mesh like network (called lattices) and can become an overkill in network settings with large unpredictable churn of nodes; like CRDTs, OT methods require large memory resources to synchronize stateful application needs like insertion of whitespaces, bracketing, etc. in a collaborative document; increase their need for storage space by a significant amount; cannot deal with process and data causality at the same time; develop intricate protocols for dealing with conflicts; cannot deal with numerous nodes leaving and joining a network cluster continuously or in large numbers; do not provide a safe data restore plan from backups/replicas.

### SUMMARY OF THE INVENTION

In one aspect, a computerized system comprising: a plurality of nodes interlinked by uniform or non-uniform communication links, wherein each node of the plurality of nodes switches between a propagator mode of operation or non-propagator modes of operation; wherein a first node comprises a computerized synchronization system, wherein the computerized synchronization system synchronizes the data in the plurality of nodes and tracks of all events made on one or more local data units and synchronizes along with the identifiers of the plurality of nodes: a local data storage system that saves and retrieves a plurality of timestamps; a processor to perform basic atomic operations on the plurality of timestamps; an internal clock, wherein a time of the internal clock is modulated by a device; a device which receives messages and data and measures a time of reception and a control time of sending messages and data; a central controller to coordinate all the components in the device; a mode modulator that performs a propagator mode operational transition or a non-propagator mode operational transition; and an internal log that maintains a log of history of events and changes made within a node.

### BRIEF DESCRIPTION OF THE DRAWINGS

The present application can be best understood by reference to the following description taken in conjunction with the accompanying figures, in which like parts may be referred to by like numerals.

FIG. 1 is a block diagram illustrating the overall architecture of the system, according to some embodiments.

FIG. 2 is an example illustration of synchronization system in an ad hoc network, according to some embodiments.

FIG. 3 is an example illustration of synchronization system in an ad hoc network with propagator nodes, according to some embodiments.

FIG. 4 is a flowchart illustrating an overall operation of the synchronization system, according to some embodiments.

FIG. 5 is a flowchart illustrating a suboperation in a node, pertaining to broadcasting an ID, according to the invention, according to some embodiments.

FIG. 6 is a flowchart illustrating a suboperation in a node, pertaining to broadcasting data, according to some embodiments.

FIG. 7 is a block diagram of an atomic data structure called timestamp, according to some embodiments.

FIG. 8 is a block diagram listing various operations that can be performed on timestamp(s), according to some embodiments.

FIGS. 9 and 10 are block diagrams illustrating the evolution of a timestamp after two events, according to some embodiments.

FIG. 11 is a block diagram illustrating the application and composition of various atomic operations on timestamps, according to some embodiments.

FIG. 12 is a block diagram illustrating the application and composition of various atomic operations on timestamps, according to some embodiments.

FIG. 13 is a block diagram illustrating the application and composition of various atomic operations on timestamps, according to some embodiments.

FIG. 14 is a block diagram illustrating the application and composition of various atomic operations on timestamps, according to some embodiments.

FIG. 15 is a block diagram illustrating the application and composition of various atomic operations on timestamps, according to some embodiments.

FIG. 16 is a block diagram illustrating the application and composition of various atomic operations on timestamps, according to some embodiments.

FIG. 17 is a block diagram illustrating the application and composition of various atomic operations on timestamps, according to some embodiments.

FIGS. 18 A-B are block diagrams illustrating the application and composition of various atomic operations on timestamps, according to some embodiments.

FIG. 19 is a block diagram illustrating the application and composition of various atomic operations on timestamps, according to some embodiments.

FIG. 20 is a flow chart illustrating a suboperation in a node, pertaining to mode selection, according to some embodiments.

FIG. 21 illustrates another example process utilized herein, according to some embodiments.

FIG. 22 depicts an exemplary computing system that can be configured to perform any one of the processes provided herein.

The Figures described above are a representative set and are not exhaustive with respect to embodying the invention.

### DESCRIPTION

Disclosed are a system, method, and article of manufacture for distributed synchronization. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

The following terminology is used in example embodiments:

ACID (atomicity, consistency, isolation, durability) is a set of properties of database transactions intended to guarantee data validity despite errors, power failures, and other mishaps. In the context of databases, a sequence of database operations that satisfies the ACID properties (e.g. can be perceived as a single logical operation on the data) is called a transaction. For example, a transfer of funds from one bank account to another, even involving multiple changes such as debiting one account and crediting another, is a single transaction.

Conflict-free replicated data type (CRDT) is a data structure whose concurrent operations commute, hence the name. Strong eventual consistency can be achieved with CRDTs. Using CRDT, it is possible to replicate data across numerous nodes and apply updates without necessarily requiring a central server to be synchronized with the rest of the network. Both state-based and operation-based CRDT exist. In some examples, CRDT is a data structure that is replicated across multiple computers in a network, with the following features. The application can update any replica independently, concurrently and without coordinating with other replicas. An algorithm (e.g. itself part of the data type) automatically resolves any inconsistencies that might occur. Although replicas may have different states at any particular point in time, they are guaranteed to eventually converge.

Datacenters are large facilities designed to accommodate multiple computer systems and their ancillary components, such as telecommunications and mass storage.

Nodes can be a datacenter, agents, computer systems, wireless router, etc.

OT (Operational transformation) is an alternative technique to CRDTs for implementing real time (e.g. assuming computing and/or networking latencies, etc.) collaboration technique. OT can allow a group of users to concurrently edit the same content using finite state model machinery. OT can support a range of collaboration functionalities in advanced collaborative software systems. OT was originally invented for consistency maintenance and concurrency control in collaborative editing of plain text documents. OT capabilities can be extended, and OT applications can be expanded to include group undo, locking, conflict resolution, operation notification and compression, group-awareness, HTML/XML and tree-structured document editing, collaborative office productivity tools, application-sharing, and collaborative computer-aided media design tool.

Reclaiming storage space taken up by objects that are no longer in use by the system is one function of garbage collection, a form of memory management (and/or program).

Strong eventual consistency can be a system in which replica conflicts are impossible. In one example, strong eventual consistency can guarantee that when all nodes have received the same set of updates and are in the same state. These can be regardless of any order in which updates have been applied. Strong eventual consistency can be obtained through conflict-free replicated data types (CRDTs) and/or operational transformation (OT).

These definitions are provided by way of example and not of limitation. They can be integrated into various example embodiments discussed infra.

Example Systems and Methods

The following description is offered in the context of a network consisting of a collection of nodes or stations, mobile or stationary, interconnected by wireless or radio transmission medium, in order to better comprehend the concept realized by the approach. In most cases, the collection of nodes will function as a network. Each node is equipped with its own identification, clock, data storage (local cache), and processing power. It is expected that early discrepancies exist between data and clocks.

The idea behind the method is to dynamically identify a subset of nodes as propagators to optimize message transmission for equitability, accessibility, and efficiency in ad hoc networks with no physical infrastructure or centralized administration for synchronization. These propagator nodes of the network act as major synchronization message broadcasters, flow support and connectivity managers to reduce transmission overhead of the network. The propagators may not be fixed and can dynamically change based on operating environment such as underlying network topology, etc. In other words, the method forms a coalition of nodes (called propagators), in a distributed fashion, to reduce overall network transmission, synchronization and causality tracking costs.

The method dynamically forms coalitions (propagator nodes) by encouraging those nodes which already belong to the coalition to remain in the coalition and encourage those nodes which are not in the coalition, but are adjacent with some propagator node, to join the coalition. A reason why methods only encourage nodes neighboring propagator nodes to join the coalition is to enhance quick convergence to a minimal set of propagator nodes and maintain robustness. The method also provides an incentive for propagator nodes to leave the coalition, which ensures a small coalition size. To realize these ideas, a mode modulating function has been designed to ensure that it yields higher values for the desirable effect.

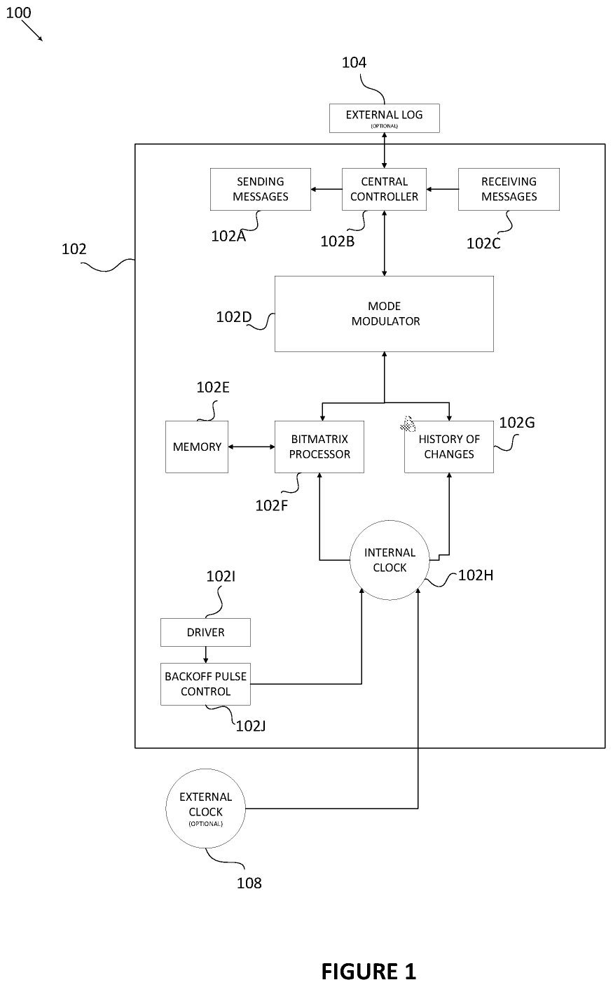

FIG. 1 is a schematic depicting proposed synchronization mechanism. Typically, the proposed system 102 can be found in a station, router, or a node in a network. As an illustration, it consists of the following components:

A local data storage 102E (e.g. local caching) system to save and retrieve timestamps (a timestamp can encode both id information and event information in a single bitmatrix)

A processor to perform basic atomic operations on timestamps 102F;

An internal clock 102H, the time of which is modulated by a device 1021 and 102J;

A device which can receive messages and data 102C; and can measure the time of reception and control time of sending messages and data 102A;

A central controller to coordinate all the components in the device 102B;

A mode modulator to perform propagator or non-propagator mode operational transitions 102D; and

An internal log 102G to keep history of events, changes, etc., such as a table of diffs made within the node;

An optional external (global) logging mechanism to recycle any unused IDS 104; and

An optional external (global) clock 108.

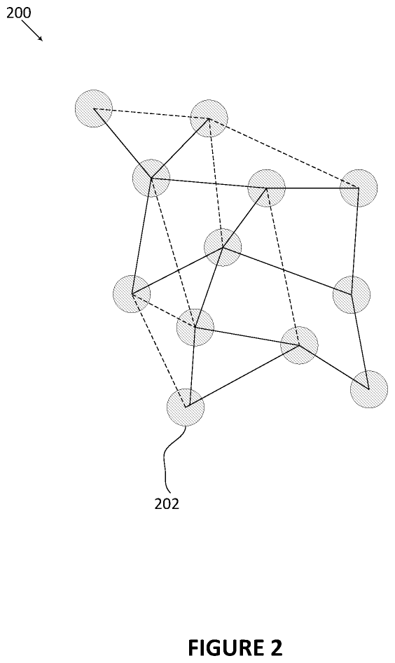

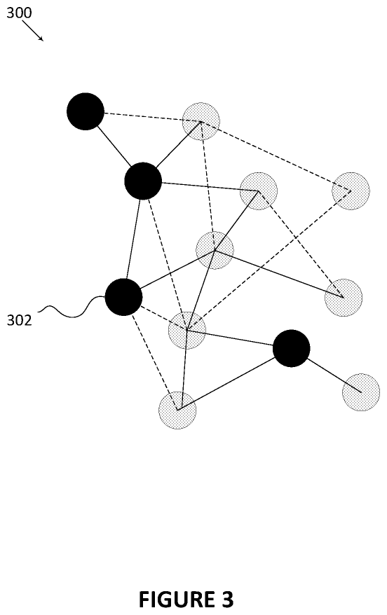

FIGS. 2 and 3 diagrammatically represent the operational context of the system. It comprises a plurality of nodes 203 interlinked by uniform or non-uniform communication links, illustrated by solid and dashed lines. Nodes may switch between propagator or non-propagator modes of operation. For example, solid black filled nodes 302 are in propagator mode and the others are in non-propagator modes. The internal clocks of nodes may not be synchronized initially, and the proposed system operates differently according to the organization of the network to which it is applied, some exemplary applications of which are provided here.

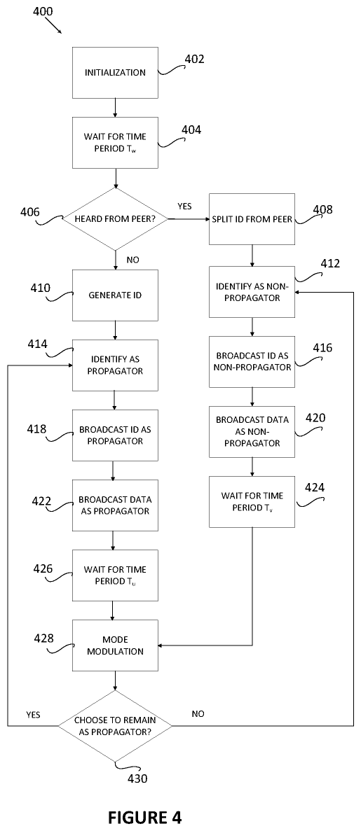

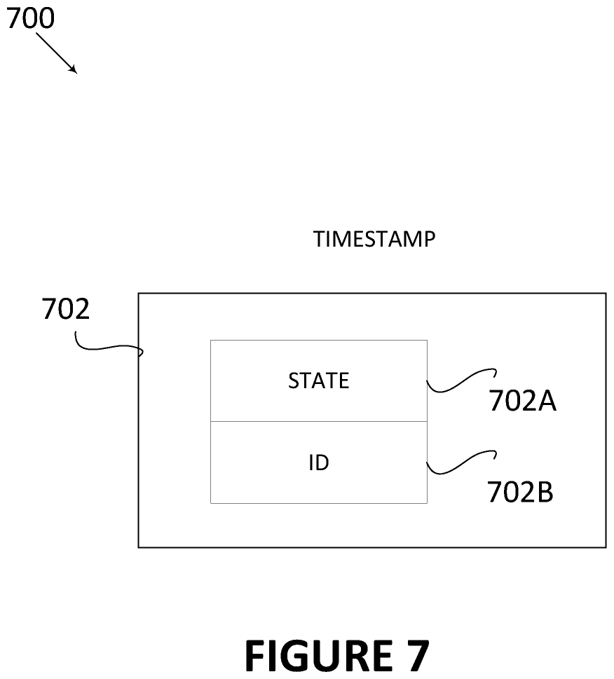

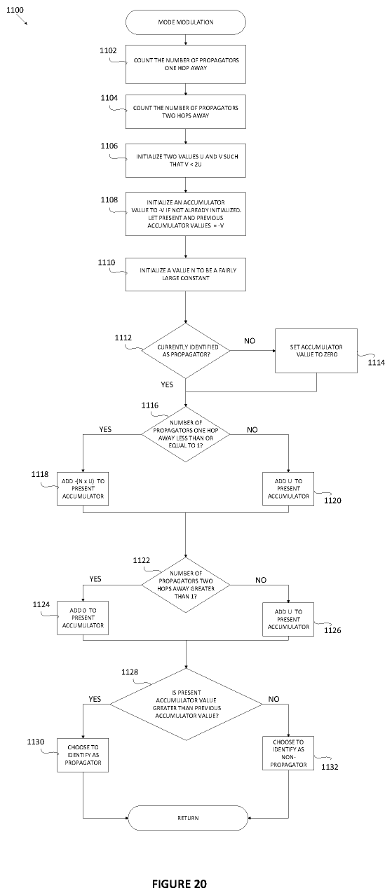

Replicas of data elements may reside on various nodes (each with a unique ID) and each node may operate on its local copy, even in an offline first manner. The method synchronizes the data and keeps track of all events made on data units locally, along with the ID of respective nodes distributively. The method performs this task using messages exchanged between nodes and their immediate neighbors. The method makes use of a bit vector data structure called timestamp 702 (FIG. 7) and a dynamically adaptive coalition seeking protocol (operation illustrated as a flowchart in FIG. 20). FIG. 4 represents a flowchart of the synchronization and causality tracking mechanism of the system.

The method presupposes that the lifecycle of operations in a node is performed as follows:

During the initialization process 402, a node instantiates various internal clocks, drivers and sending and messaging buffers, network transmission queues, etc., ready to react upon local timeout and arrival of an announcement message from its peers. A node is made aware of its local context by receiving announcement messages. Once such local context can be the set of nodes within one hop and their mode of operation. A node keeps receiving announcement messages, tries to perceive the local context as much as it can, and reacts upon any changes. In a dynamically changing environment, such announcement messages may not contain complete local context of the peers of a node and only a partial set of peers may send announcement messages.

After initialization, each node generates announcement messages periodically with interval T_{w} 404, the announcement message may optionally contain its timestamp information, which will be described in detail later. Each node has its own internal clock, which may not always be synchronized. Hence, even if the waiting interval T_{w} 404 is common to all nodes, the announcement messages may not be generated simultaneously and reduces the probability of a collision when a plurality of nodes try to access a common wireless channel. A backoff timer T_{w} may be chosen randomly using any known technique such as a sliding window-based timer backoff, etc. Additionally, a node may only change its mode of operation (propagator to non-propagator or vice-versa) just before an announcement message is about to be generated. A node may not change its mode of operation, keep the change in mode to itself, and inform its peers at some time later.

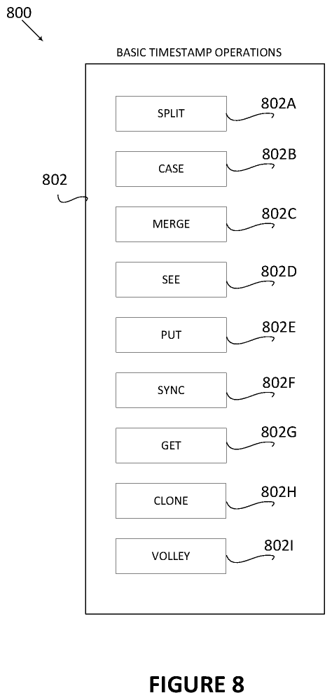

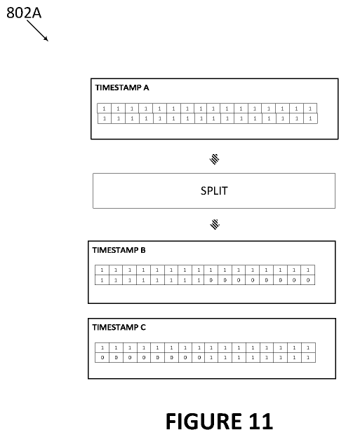

While in backoff period, if a node hears from a peer 406, it proceeds to generate an ID for itself based on the ID of its peer 408 and operates in a non-propagator mode. Else, it generates a random ID for itself 410 and operates in a propagator mode. This process of ID generation and related state/event tracking is performed using a timestamp data structure 702 (FIG. 7) and its related timestamp operations 802 (FIG. 8). Step 408 happens via split operation, illustrated in FIG. 11. For better utilization of ID space and to avoid repeatedly subdividing the range of ID values, the node may wait for announcements from a few peers and choose a peer at random and split its ID.

In one preferred embodiment, the peer node reads its ID vector from its storage and performs a split operation locally. The peer node then picks one of the resulting ID and overwrites its existing ID vector in its storage. The peer node must wait for all ongoing operations with its old ID to finish before overwriting it with new one. The peer node may then send the split ID to the requesting node, which the requesting node stores on its disk locally.

In another embodiment, the node may wait till it hears from a set of peers and choose one peer randomly. The split operation may then be performed locally and communicated to the peer node, or it may be performed non-locally on peer node and communicated to the requesting node.

When the node doesn't hear from any of its peers within its timeout limit, it generates a random ID vector (for example a 16-bit vector) and enters into propagator mode.

While operating in the propagator mode 414, the node performs its ID and data broadcasting 418 and 422 in the following way:

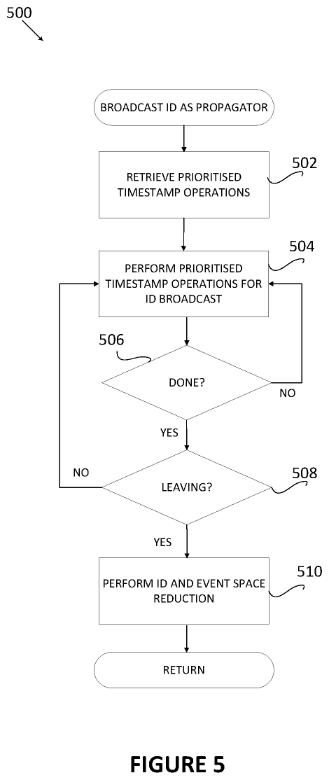

FIG. 5 illustrates a flowchart depicting the ID broadcasting lifecycle of a propagator node. At step 502, various atomic timestamp operations are retrieved that are prioritized according to the mode of operation. For instance, in the propagator mode, the operation precedence is thus (FIG. 8): split 802A>case 802B>merge 802C>see 802D>put 802E>sync 802F>get 802G>clone 802H=volley 802I. On the other hand, in the case of non-propagator mode, the operation precedence list is: case 802B>merge 802C>get 802G>split 802A>see 802D>sync 802F>put 802E>clone 802H=volley 802I.

In step 504, the propagator node may apply local operations or changes to local data, perform case 802B operation to lodge the event, merge 802C any pending timestamps and make a local copy of timestamp see 802D to persistent storage and announce its state using put 802E operation. It then awaits writes and other requests from peers using get 802G operation. The node may also perform other housekeeping operations based on underlying application. If, in its lifecycle, a node wishes to leave the network cluster 508, an ID and state/event space reduction step is performed 510. In step 510, the node stops accepting all write requests and blocks get 802G operation. It then performs a sync 802F operation with its peers. Next, it retrieves and deletes its local ID from its storage.

In one preferred embodiment, the node may choose one peer at random and request a merge 802C operation with it to recycle the ID space. The peer may also accept the ID directly. In another embodiment, the node may log the ID externally into a logging mechanism and then the ID may be recycled later. When sending the ID, in case of network errors or timeouts, the node may not resend the ID for recycling.

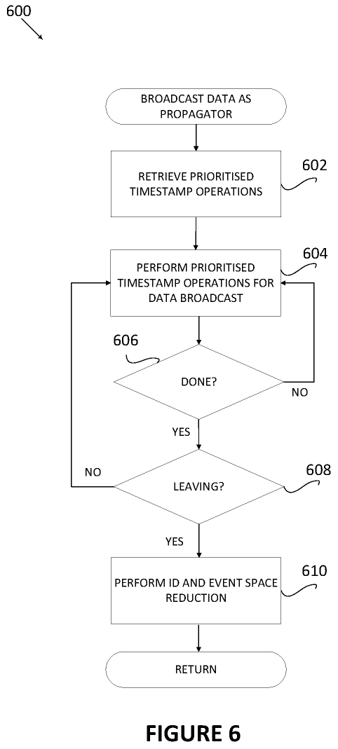

FIG. 6 illustrates a flowchart depicting the data broadcasting lifecycle of a propagator node. Step 602 is same as step 502 (FIG. 5) described above. In step 604, the propagator node maintains points to data segments, and whenever it makes a change to a data segment, perform case 802B operation and save a diff of the data (i.e., maintain a log of the correction and save the history of edits, etc., in persistent storage). Whenever a peer requests for data, simply return the diff (or the data) along with a see 802D operation, followed by put 802E operation. This is to avoid data corruption and causality loss in case of a node crash or network failure, etc. In the meantime, it awaits any requests 606 for sync 802F operations from peer. When sending data to synchronize, the propagator node only sends the state vector (event vector) for each data segment. In one preferred embodiment, sending the ID is avoided to reduce transmission overhead. While awaiting to process requests 606, if new data comes from peers, the propagator node retrieves the latest local timestamp entry for the received data segment. If the received timestamp is greater than the local timestamp entry, overwrite the local timestamp with received timestamp and modify the data segment accordingly. In case of a conflict, a volley 802I operation is performed. The volley 802I operation ensures the conflicting entries either are tracked under local ID and can be further resolved using a pre-specified conflict resolution rulesets in real-time or fixed manually later.

In one embodiment, the node may interact with a client that may not have a timestamp or an ID to begin with. In that scenario, the node may act as a proxy to the client and proceed to split its own ID and resulting ID to each other. It may also perform the timestamp housekeeping locally on behalf of the client. Steps 608 and 610 are same as 508 and 510 (FIG. 5)

The non-propagator mode of operation (steps 416 and 420) is also similar to propagator mode of operation (418 and 422). However, the only difference is in the operation precedence as mentioned above. A non-propagator node is both a write and read heavy node and mainly refrains from making frequent volley 802I operations. Propagator nodes, on the other hand, can be seen as read heavy nodes. With specified timeout intervals for both propagator 426 and non-propagator modes 424, a node can switch between bot modes, decision of which is made in step 428. Step 428 mainly acts as a feedback loop 430 in the lifecycle of a node, the operations of which are illustrated in the flowchart in FIG. 20.

FIG. 20 presents a procedure to determine when and how a node changes its operating mode (from propagator to non-propagator or vice-versa). A node essentially gathers the local context around it by counting for number of propagator nodes one hop 1102 and two hops 1104 away from it. Because some nodes may choose to not announce their state and some communication links may be too volatile, a very small timeout window may be enough to compute a rough estimate. In step 1106, two values U and V are chosen such that 2U>V. Next, a previous value of an accumulator is read from memory 1108. If it is not present already, it is initialized to −V. In step 1110, a value for N, ideally a rough estimate of the number of nodes is initialized. In 1112, if the node is already a propagator node, the present accumulator value is set to zero 1114. Else, if more than one of its peers are propagators 1116, then U is added to present accumulator value 1120. Otherwise, (N×U) is subtracted from the present accumulator value 1118. The same test is made for nodes two hops away from node 1122. If there are two or more propagator two-hop neighbors, accumulator value is left unchanged 1124. Otherwise, U is added to it 1126. If it is seen that the accumulator value has increased from its previous value 1128, the mode of operation is set to propagator 1130. Otherwise, the mode is set to non-propagator.

This process ensures that there is always an optimal balance of propagator and non-propagator nodes, that are dynamically adaptable to network topology and changing cluster memberships, to reduce communication costs, reduce synchronization and causality tracking overhead, etc.

The timestamp data structure and its related operations are described in detail below:

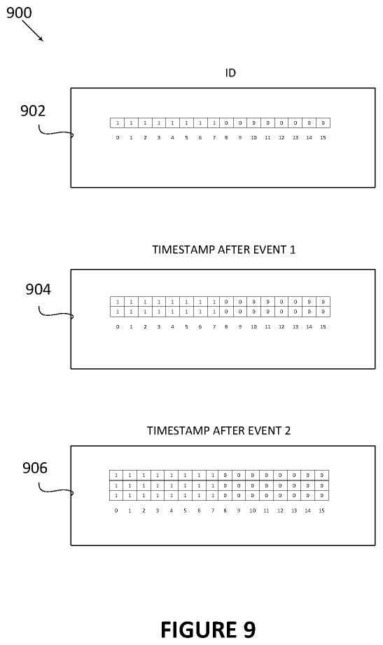

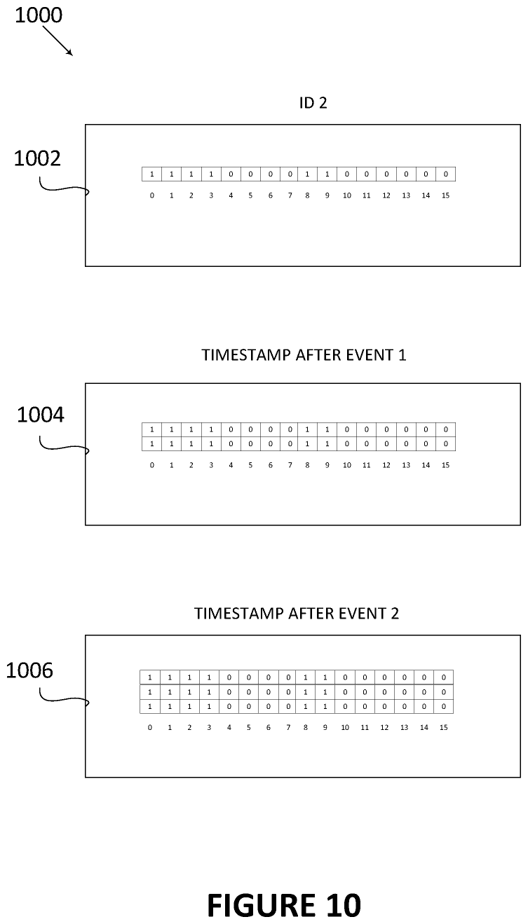

The timestamp 702 is essentially a bit matrix encoding the ID and state of a node. Considering a 16-bit vector to illustrate the principle by an exemplary operation, a node may have an ID as depicted by 902 (FIG. 9). To track causality of changes to data and avoid collisions, whenever the node makes a state change (i.e., lodges an event) to the data, another bit vector is stacked on top with those bits set to 1 whose corresponding bits in ID vector are also 1. This illustrated by 904. After lodging another event, the node updates its timestamp by stacking another vector on top with corresponding bits in the ID vector set to 1. Being binary matrices with high localized repeatability, this data structure is amenable to better compressions and also easy to be operated upon without decompressing it. Another exemplary evolution of a timestamp 1001 and 1006 for a different ID 1002 is illustrated in FIG. 10.

FIG. 8 illustrates a block diagram of various atomic operations that are also composable, that can be operated upon timestamps. FIG. 11 presents an example of the split 802A operation to illustrate the principle. The split operation 802A allows copying the causal history of a timestamp, resulting in a pair of timestamps that have identical state vectors but distinct ID vectors. FIG. 11 shows splitting the ID from timestamp A into timestamp B and timestamp C. Generally, either timestamp B or timestamp C overwrites the value of timestamp A, and timestamp A ceases to exist or is added to the external log for recycling.

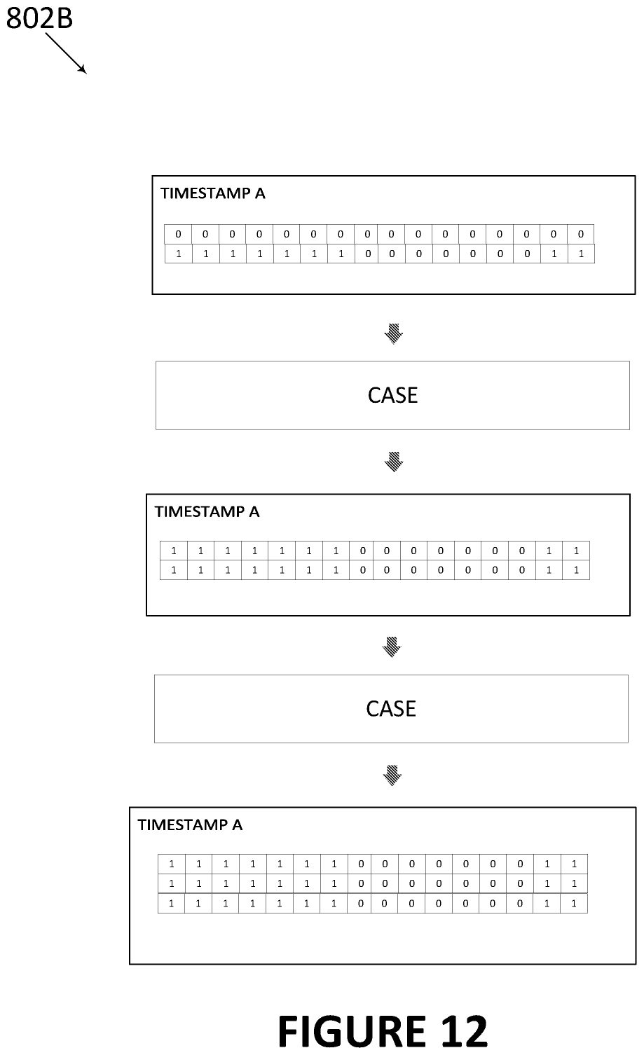

FIG. 12 presents an example of the case 802B operation to illustrate the principle. The case operation 802B adds a new state to the state vector, effectively incrementing a counter associated with the ID vector. Whenever the data is modified, the counter is incremented as illustrated after the second application of case operation in FIG. 12.

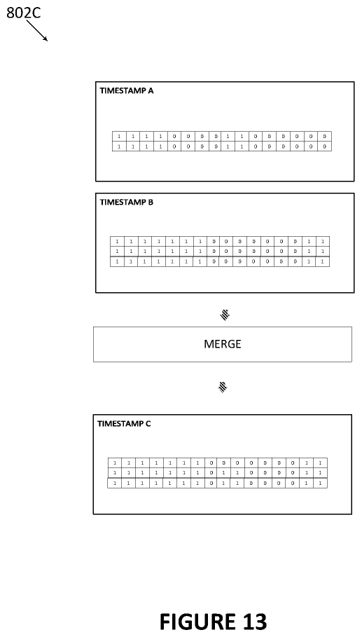

FIG. 13 presents an example of the merge 802C operation to illustrate the principle. The merge operation 802C merges two timestamps, resulting in a new one. The merge operation can be effectively seen as a pointwise maximum of two bit-matrices.

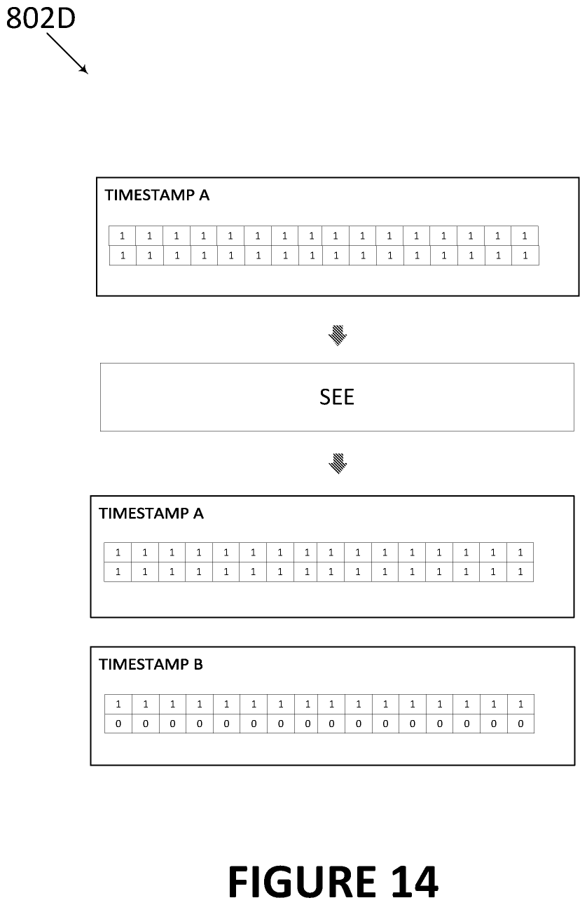

FIG. 14 presents an example of the see 802D operation to illustrate the principle. The see operation 802D produces an anonymous timestamp (timestamp B from FIG. 14) in addition to copying the original timestamp. The see operation can be used for backup purposes, as inactive copies and for debugging of distributed corrections.

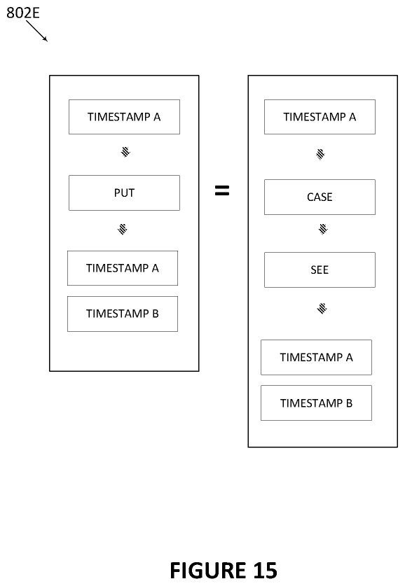

FIG. 15 presents an example of the put 802E operation to illustrate the principle. The put operation 802E is an atomic composition of case 802B operation followed by see 802D operation. The put operation 802E effectively increments the state counter and creates a new timestamp message.

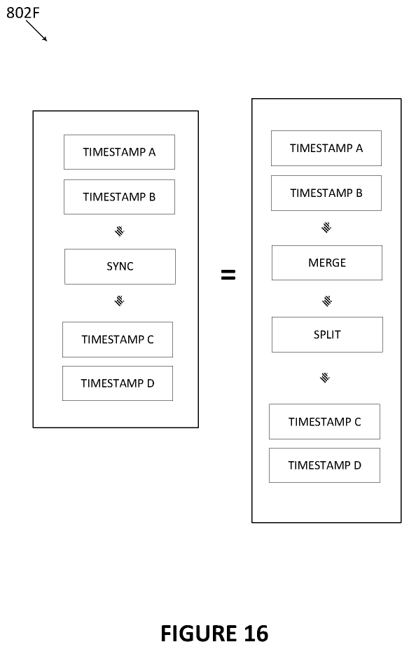

FIG. 16 presents an example of the sync 802F operation to illustrate the principle. The sync operation 802F is an atomic composition of merge 802C operation followed by split 802A operation. The sync operation 802F effectively synchronizes two replicas.

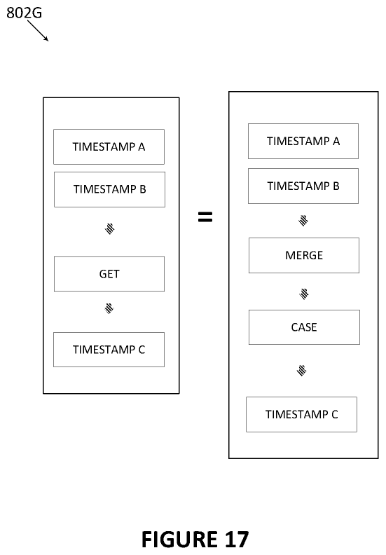

FIG. 17 presents an example of the get 802G operation to illustrate the principle. The get operation 802G is an atomic composition of merge 802C operation followed by case 802B operation. The get operation 802G effectively takes a pointwise maximum of bit-matrices and follows it up with incrementing the state counter.

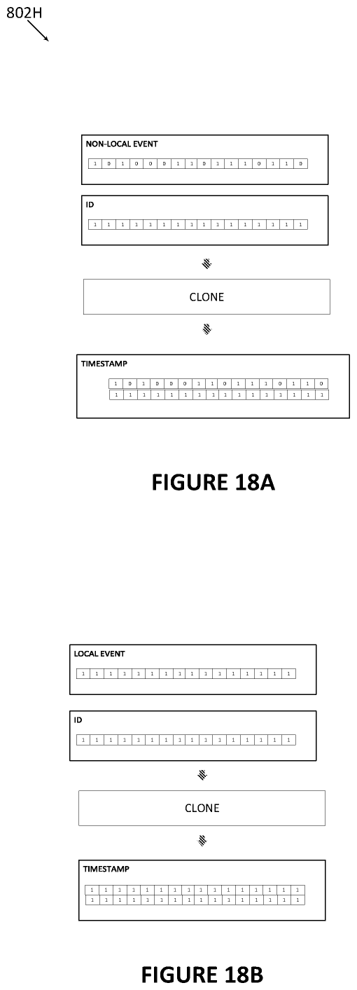

FIGS. 18A and 18B present an example of the clone 802H operation to illustrate the principle. The clone operation 802H is an atomic operation that produces a local copy of a timestamp with the ID of the local node and the state vector of a non-local node (FIG. 18B) or with the ID of the local node and the state vector of the local node (FIG. 18B). The clone operation 802H is mainly useful in making complete local copies of timestamps.

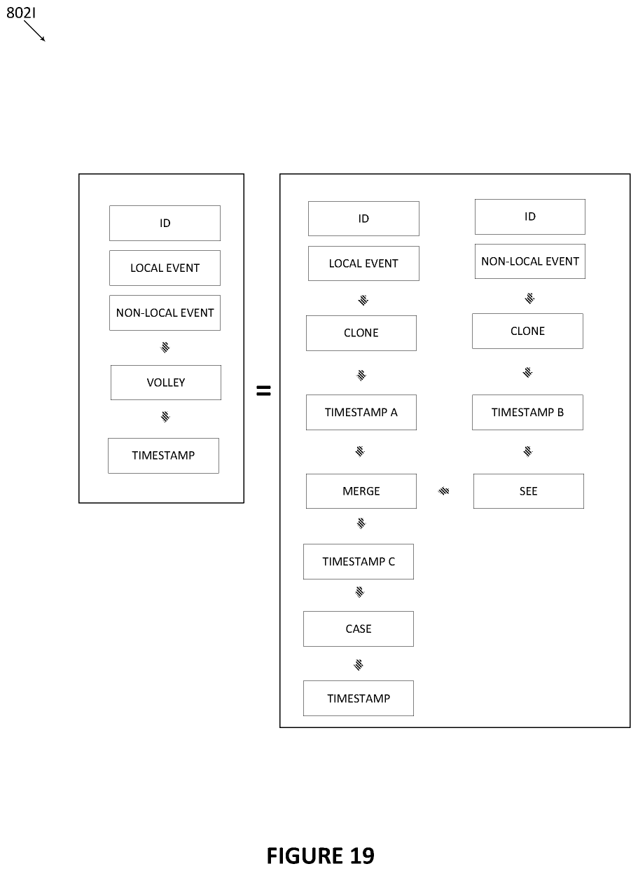

FIG. 19 presents an example of the volley 802I operation to illustrate the principle. The volley 802I operation is an atomic operation that makes a complete copy of the conflicted timestamp between one or more nodes. The volley operation 802I essentially makes a complete copy of the timestamp (with local state/event counter) 802H, followed by making a complete copy of the non-local timestamp (with local id and non-local state/event counter) 802H and making it read-only by applying see operation 802D, followed by merge operation 802C on the two copies, and eventually applying the case operation 802B to increment the state vector with local ID of the node.

Ordering of the timestamps indicates causality of data change precedence and allows the nodes to enforce the same ordering in their writes. Writes which are considered to have concurrent timestamps are permitted to have any ordering. In some embodiments, nodes may have dedicated hardware, to initially record the writes they receive, with metadata about each write pre-pending the data. Writes are thus persisted, and acknowledgement messages may be sent to other nodes signaling completion of data backup. In some embodiments, nodes may choose to not communicate their local ID with other nodes, and only receive state vectors (and optionally non-local IDs from other nodes) and perform conflict resolution internally.

Without departing from the framework of the invention, the steps described above at the node cluster level also apply to group cluster level. If there is a set of network clusters, causality tracking of changes to data and synchronization among them is obtained by aligning one network cluster with another by forming inter coalition nodes and merging timestamps from network clusters.

Referring to an example architecture of the synchronization and data causality tracking system 102 (FIG. 1), an exemplary embodiment may have the mode modulator 102D implement the mode modulation 428 (FIG. 4) module. A bitmatrix processor 102F may operate upon the timestamps (stored as bit matrices) and execute various timestamp operations 802 (FIG. 8). All data changes and event logs may be stored in a persistent storage or a log management module 102G. The central controller 102B may handle the initialization procedure 402 (FIG. 4) of the system, interfacing with network drivers, establishing communication links, coordinating with other controllers, sending, and receiving network and message queues, optional logging with external logging mechanisms 104 to recycle lost or retired IDs, etc. The internal clocks of nodes 102H may interface with an optional external reference clock 108, or the nodes may communicate via messages to control clock drift and synchronize their times, based on the application needs. The internal clock may be controlled by a driver 1021 with a backoff timing pulse control 102J like sliding-window technique, etc.

In one preferred embodiment, the central controller may detect that the node is offline and combine various diffs written by the node locally while it remains offline. When the node comes back online or connects with the network, it initiates the data causality and synchronization procedure as illustrated in FIG. 4.

In another embodiment, the node may send the combined diffs to peers once it comes back online from being offline and request other nodes to apply the diffs and send the full data to synchronize non-locally.

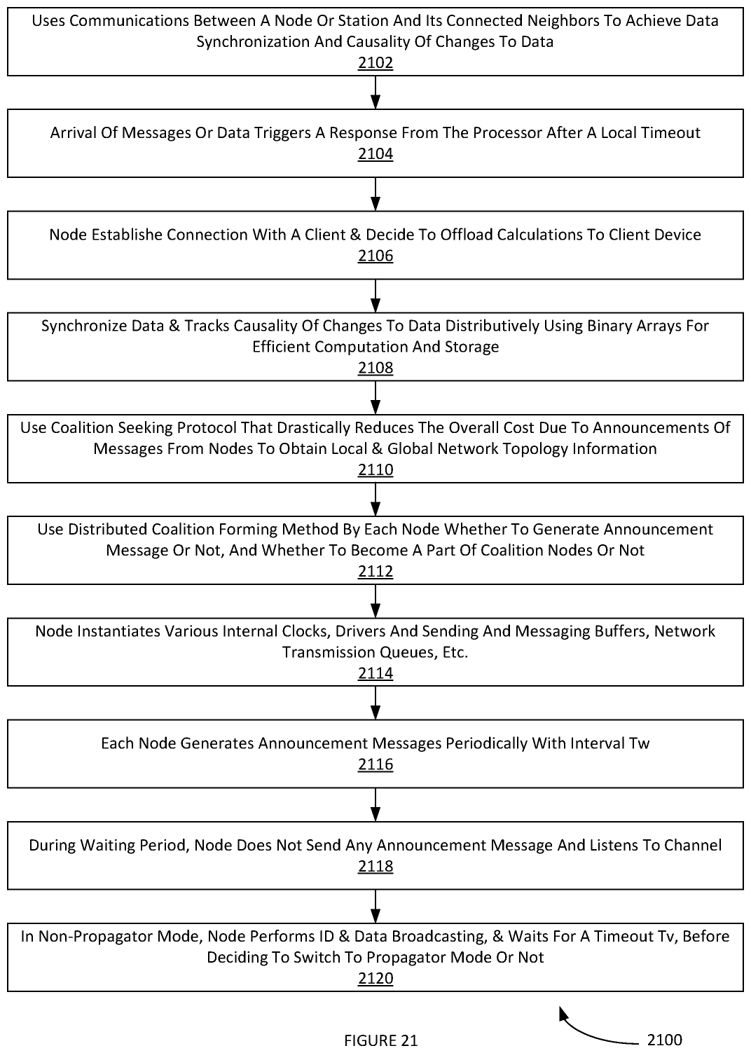

FIG. 21 illustrates another example process 2100 utilized herein, according to some embodiments. In step 2102, process 2100 uses communications between a node or station and its connected neighbors to achieve data synchronization and causality of changes to data. In step 2104, the arrival of messages or data triggers a response from the processor after a local timeout. In step 2106, a node can establish a connection with a client (for the purpose of pushing or pulling data and messages) and decide to offload the calculations to the client device.

In step 2108, process 2100 synchronizes data and tracks causality of changes to data distributively using binary arrays for efficient computation and storage, and a coalition seeking messaging protocol to reduce transmission costs. FIGS. 2 and 3 diagrammatically represent an exemplary ad hoc network. Each node may have some transmission range, and two nodes are considered to be linked if they are within the transmission range of either node. Each node may hold a replica of data and operate upon it independently. To track the causality of changes to data, aid synchronization and manage conflicts, a data structure based on binary arrays, called timestamp, is used.

In step 2110, process 2100 uses a coalition seeking protocol that drastically reduces the overall cost due to announcements of messages from nodes to obtain local and global network topology information. The protocol works even for nodes that can only receive but cannot send announcement messages. The designed data structure and its atomic and composable operations allow unbounded generation of unique IDs with little or zero computational and memory overhead. A special procedure, external to the system, to recycle unused IDs may also be employed, but is not necessary, for optimal performance of the method.

In step 2112, process 2100 uses a distributed coalition forming method by each node whether to generate announcement message or not, and whether to become a part of coalition nodes or not. It is noted that during the synchronization, a node may change from a propagator mode to a non-propagator mode, or vice-versa. To control the process of such changes, each node is equipped with a mode modulator. After initialization, a node essentially operates in two modes: propagator or non-propagator.

In step 2114, during the initialization process, a node instantiates various internal clocks, drivers and sending and messaging buffers, network transmission queues, etc., ready to react upon local timeout and arrival of an announcement message from its peers. A node is made aware of its local context by receiving announcement messages. Once such local context can be the set of nodes within one hop and their mode of operation. A node keeps receiving announcement messages, tries to perceive the local context as much as it can, and reacts upon any changes. In a dynamically changing environment, such announcement messages may not contain complete local context of the peers of a node and only a partial set of peers may send announcement messages.

In step 2116, after initialization, each node generates announcement messages periodically with interval Tw, the announcement message may optionally contain its timestamp information, which will be described in detail later. Each node has its own internal clock, which may not always be synchronized. Hence, even if the waiting interval Tw is common to all nodes, the announcement messages may not be generated simultaneously and reduces the probability of a collision when a plurality of nodes try to access a common wireless channel. A backoff timer Tw may be chosen randomly using any known technique such as a sliding window-based timer backoff, etc. Additionally, a node may only change its mode of operation (propagator to non-propagator or vice-versa) just before an announcement message is about to be generated. A node may not change its mode of operation, keep the change in mode to itself, and inform its peers at some time later.

In step 2118, during the waiting period (e.g. with a backoff timer), a node does not send any announcement message and listens to the channel. If it receives an announcement from a peer node, it splits the ID of the peer, assigning one of the resulting IDs to itself (e.g. the other resulting ID is assigned to the peer node), and goes into the non-propagator mode. If on the other hand, it does not receive any announcement from its peers, the node then generates a random bit vector. With numerous IoT devices, wireless sensors, and PDAs, etc., having less memory resources, operations involving a 16-bit vector ID are illustrated. However, the same efficacy is achieved even with 8-bit, 32-bit, 64-bit, or even higher word length bit vectors. After generating an ID and assigning to itself, the node enters into propagator mode.

In step 2120, in the non-propagator mode, the node performs ID and data broadcasting, and waits for a timeout Tv, before deciding to switch to propagator mode or not. It evaluates a mode modulating function to make that decision and proceeds accordingly with the prescription. In a similar fashion, when operating in propagator mode, the node performs ID and data broadcasting, and waits for a timeout Tu, before deciding to switch to non-propagator mode or not. It evaluates a mode modulating function to make that decision and proceeds accordingly with the prescription.

Both modes of operation (e.g. propagator and non-propagator) behave in similar ways, except in the priority orders they assign to various timestamp operations. That is, a propagator node and a non-propagator node behave exactly the same, while differing only in the priority they assign to various timestamp operations. A timestamp is essentially a compact encoding of various event counters made by a node, tagged by its ID, during its lifetime. The timestamp operations pertain to various composable atomic operations that help track causality of changes to data distributively.

Additionally, process 2100 is fairly robust against rogue nodes. The communication protocol and time stamp operations ensure corrupt ID and events propagated by a few rogue nodes are tagged and distributed for further resolution by other nodes.

It is noted that an example difference between two data units can be written to memory, a mass storage device, or some other persistent medium using the diff operation. An example of a data ad hoc network is a worldwide interconnection of databases that guarantee data integrity via commutative replication. For example, hundreds of data centers and billions of embedded databases in devices can be brought into sync with one another and their data causality tracked with the help of a data ad hoc network. Lossless offline accessibility is possible with a data ad hoc network. If every node in the system can observe memory actions that could be causally related in the same order, then the system can be said to have causal consistency.

Example methods is general purpose and distributed in nature and is well suited for both dynamic and static systems. Garbage collection is not necessary. IDs are automatically reused by the nature of timestamp datatype and operations defined on it. Example methods enforces data causality rather than merely detecting conflicts. Example methods work based on the principle of coalition formation using only local data. It is local in the sense that each node makes a decision based only on information in its neighborhood. Example methods can work well in environments where nodes are added and removed continuously. Example methods places less requirements on the ad hoc networks by dynamically partitioning it into propagator and non-propagator nodes, thus reducing number of synchronization and data change messages. Example methods reduces memory consumption on nodes (e.g. wireless sensor devices and IoT devices) by selecting bitmatrix based encoding. Example methods reduce data update latencies by dynamically choosing the transmission path via coalition nodes (propagators). Example methods can be self-organizing in the sense that all nodes can make decisions by themselves simultaneously. Example methods can manage the addition and removal of nodes or connections automatically and is quite robust. Example methods can be efficient in the sense that it converges to an optimal and minimal set of coalition nodes in a very short time to minimize energy consumption of devices and network transmission overhead. Example methods allow for the fragmentation and recombination of subnetworks owing to connection issues, network 1/O delays, etc.

Example methods can provide faster consistency convergence in primarily offline environments with a restricted capacity to determine the true (and dynamic) size of the node cluster/subnetwork. Example methods can provide an efficient and secure method for managing changesets that are not always monotonically mergeable. Example methods can provide an effective and easy method to restore data from backups/replicas thus avoiding data losses. Example methods can provide protection against a small fraction of rogue nodes in the network. Example methods can also work in settings where some nodes can only receive but never send.

Example methods can provide an efficient and secure method for propagating messages (such as potential conflicts) around a network. Example methods can provide a straightforward and progressive method for enforcing causality of changes to data and minimizing synchronization problems in networks with constantly changing topologies and high node density. Example methods can allow nodes with external references of truth to be included in the network and may align the network accordingly.

Consequently, it is desirable to have a method that, inter alia: does away with the need to collect metadata for the purpose of detecting causal dependencies; uses zero or very little memory and CPU time to process varying network configurations; makes the distributed system more responsive and improves consistency convergence and replication robustness; and does away with the need to have a master or reference node for synchronization.

It is desirable to use the micro- and macro-level responsiveness and consistency convergence gains from distributed systems to greatly enhance the Internet's and CDNs' responsiveness.

Additional Computing Systems

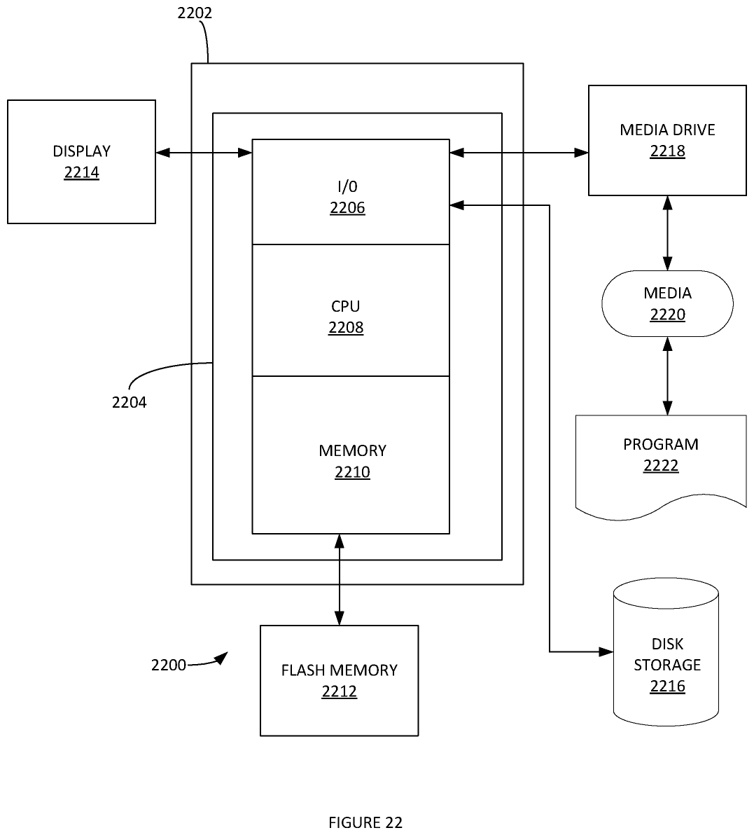

FIG. 22 depicts an exemplary computing system 2200 that can be configured to perform any one of the processes provided herein. In this context, computing system 2200 may include, for example, a processor, memory, storage, and I/O devices (e.g. monitor, keyboard, disk drive, Internet connection, etc.). However, computing system 2200 may include circuitry or other specialized hardware for carrying out some or all aspects of the processes. In some operational settings, computing system 2200 may be configured as a system that includes one or more units, each of which is configured to carry out some aspects of the processes either in software, hardware, or some combination thereof.

FIG. 22 depicts computing system 2200 with a number of components that may be used to perform any of the processes described herein. The main system 2202 includes a motherboard 2204 having an I/O section 2206, one or more central processing units (CPU) 2208 and/or graphical processing unit (GPU), and a memory section 2210, which may have a flash memory card 2212 related to it. The I/O section 2206 can be connected to a display 2214, a keyboard and/or another user input (not shown), a disk storage unit 2216, and a media drive unit 2218. The media drive unit 2218 can read/write a computer-readable medium 2220, which can contain programs 2222 and/or databases. Computing system 2200 can include a web browser. Moreover, it is noted that computing system 2200 can be configured to include additional systems in order to fulfill various functionalities. Computing system 2200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system) and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized system comprising:
a plurality of nodes interlinked by uniform or non-uniform communication links, wherein each node of the plurality of nodes switches between a propagator mode of operation or non-propagator modes of operation;
wherein a first node comprises a computerized synchronization system, wherein the computerized synchronization system synchronizes the data in the plurality of nodes and tracks of all events made on one or more local data units and synchronizes along with the identifiers of the plurality of nodes:
a local data storage system that saves and retrieves a plurality of timestamps;
a processor to perform basic atomic operations on the plurality of timestamps;
an internal clock, wherein a time of the internal clock is modulated by a device;
a device which receives messages and data and measures a time of reception and a control time of sending messages and data;
a central controller to coordinate all the components in the device;
a mode modulator that performs a propagator mode operational transition or a non-propagator mode operational transition; and
an internal log that maintains a log of history of events and changes made within a node.

2. The computerized system of claim 1, wherein the first node comprising the computerized synchronization system is implemented in a station, router, or a node in a network.

3. The computerized system of claim 1, wherein a timestamp encodes both an identifier information and an event information in a single bitmatrix.

4. The computerized system of claim 1, wherein the log of history of events and changes such as a table of diffs.

5. The computerized system of claim 1, wherein the computerized synchronization system, during the initialization process, instantiates the internal clock and the driver and a sending buffer and a messaging buffer, and a network transmission queue.

6. The computerized system of claim 5, wherein after the initialization process, each node of the plurality of nodes generates an announcement message periodically with an interval.

7. The computerized system of claim 6, wherein the announcement message comprises a timestamp information of each respective node.

8. The computerized system of claim 6, wherein a backoff period is implemented in the plurality of nodes.

9. The computerized system of claim 8, wherein during the backoff period the first node of the plurality of nodes hears from a peer node and generates an identifier for itself based on an identifier of the peer node and operates in a non-propagator mode.

10. The computerized system of claim 8, wherein during the backoff period a first node does not hear from a peer node generates a random identifier for itself and operates in a propagator mode.

11. The computerized system of claim 10, wherein a split operation if implemented to avoid repeatedly subdividing the range of identifier values, and wherein the first node waits for an announcement from a specified number of peer nodes and chooses a random peer node at random and split an identifier of the random peer node.

12. The computerized system of claim 8, wherein while operating in the propagator mode, the first node performs the identifier operation and a data broadcasting by implementing a plurality of atomic timestamp operations that are prioritized according to the mode of operation.

13. The computerized system of claim 12, wherein while operating in the propagator mode, the first node performs the identifier operation and a data broadcasting by applying a plurality of local operations or changes to local data and performing a case operation to log the event, merging any pending timestamps, making a local copy of any pending timestamps to a persistent storage, and announcing its state using a put operation.

14. The computerized system of claim 13, wherein while operating in the propagator mode, the first node then awaits writes and other requests from peer nodes using a get operation.

15. The computerized system of claim 14, wherein while operating in the propagator mode, the first node perform other housekeeping operations based on an underlying application.

16. The computerized system of claim 15, wherein while operating in the propagator mode, the first node then stops accepting all write requests and blocks the get operation, then performs a sync operation with its peer nodes, and then retrieves and deletes its local identifiers from the local persistent storage.

17. The computerized system of claim 16, wherein while operating in the propagator mode, the first node maintains a set of points to data segments, and whenever the first node makes a change to a data segment, the first node performs a case operation and saves a diff of the data.

18. The computerized system of claim 17, wherein a non-propagator node of the plurality of nodes comprises both a write and read heavy node and refrains from making frequent volley operations.

19. The computerized system of claim 18, wherein while operating in the propagator mode, the node performs the identification operation and the data broadcasting operation by:
retrieving one or more atomic timestamp operations, wherein the atomic timestamp operations are prioritized according to the mode of operation.

20. The computerized system of claim 18,
wherein while in the propagator mode, the system follows an operation precedence list and this list ranks operations in the following order: split, case, merge, see, put, sync, get, clone, and volley (which has the same priority as clone), and
wherein while in the non-propagator mode, the system follows an operation precedence list and this list ranks operations in the following order: case, merge, get, split, see, sync, put, clone (equal to volley operation).
